(19) United States
(12) Patent Application Publication
(10) Pub. No.: US 2023/0004922 A1
(43) Pub. Date: Jan. 5, 2023

(54) METHOD AND SYSTEM FOR SOLVING LARGE SCALE OPTIMIZATION PROBLEMS INCLUDING INTEGRATING MACHINE LEARNING WITH SEARCH PROCESSES

(71) Applicant: Plataine Ltd., Petah Tikva (IL)

(72) Inventors: Moshe BENBASSAT, Tsur Moshe (IL); Avner BEN-BASSAT, Even Yehuda (IL); Naomi DON YECHIYA, Givat Shmuel (IL); Gil COOPER, Yehud (IL); Ayelet LEVI, Tel Aviv (IL); Naaman LIFSHITZ, Kiryat Ono (IL); Eduard RUVINSKY, Petah Tikva (IL)

(21) Appl. No.: 17/467,217

(22) Filed: Sep. 5, 2021

Related U.S. Application Data
(62) Division of application No. 17/364,897, filed on Jul. 1, 2021.

(51) Int. Cl. G06Q 10/06; G06N 20/00

(52) U.S. Cl. CPC G06Q 10/063116; G06Q 10/06316; G06N 20/00

(57) ABSTRACT

Methods, apparatus, and computer program product, the method for determining an executable solution for a problem of scheduling work orders within an organization, comprising: obtaining a sample collection of solutions from a solution space of the problem, wherein the sample collection comprising a plurality of solutions to the problem based on a collection of goals, and wherein the sample collection includes one or more solutions optimizing a subset of the goals, the subset of the goals different from the collection of goals; and in an interactive stage: receiving from a user a collection of actual work orders to be executed; and providing to the user a suggested solution for scheduling the actual work orders, the suggested solution based on one or more solutions from the sample collection, wherein the suggested solution is a practical solution.

### TECHNICAL FIELD

The present disclosure relates to a method and apparatus for creating practical optimal solutions for large scale problems such as scheduling in general, and to creating practical executable solutions, in particular.

### BACKGROUND

Optimization problems are an integral part of life in general, and practically of any field, such as but not limited to business, manufacturing scheduling, planning optimal delivery routes between geographical locations (the “traveling salesman” problem), placement of circuits on a wafer in an electronic product, transportation, budget allocation, and many others. For example, in determining an optimal weekly schedule for a manufacturing factory, a demand set of work orders to be produced by certain due-dates is given, and it is required to assign resources to the work orders, such as raw material, machines, tools and people, at certain time slots so as complete production in such a way that business rules are satisfied, and an objective function is optimized. An example of a business rule may state that a 60 cm wide machine cannot be assigned to cut 70 cm wide raw material. Another example is that a second operation cannot start before a first operation is completed. A schedule that complies with all business rules is named ‘feasible’ or ‘valid’. Schedule quality may be calculated according to an objective function, also referred to as Z function, which may be defined as a mix of one or multiple metrics or goals such as but not limited to: due date compliance, completion time of last job (make-span), machine utilization, raw material consumption, and more. A valid schedule is said to be optimal if no other valid schedule yields a better Z value.

An optimization problem is a problem of finding one or more solutions which are superior to all other feasible solutions.

The term “best” as related to a solution is tightly associated with the problem at hand, and may be comprised of an optimal value of a Z function related to a combination of multiple factors, wherein some of which may be in conflict with each other. For example, in a product delivery problem, the term “best” can relate to minimal time until last product is delivered, minimize use of raw material, minimal production time, maximal number of products delivered within a predetermined period of time, or the like, whereby a goal like “minimize delivery time” may result in excess use of materials and be in conflict of goals like “minimize use of raw material”.

Many of the optimization problems are known to be NP-hard problems, meaning that the number of possible solutions grows exponentially with the size of problem input, stated for example in terms of work orders, time slots, machines, raw material, operation steps, personnel and tools. Hence explicit or implicit exploration of all feasible solutions to guarantee an optimal solution is practically prohibitive, and may require computer time which exceeds the allowable planning time even by the fastest computer. Therefore, such optimization problems are often addressed by using heuristic methods and approximation algorithms that are expected to converge to good solutions, but cannot be proven to be optimal.

The disclosure below focuses on scheduling of work in a manufacturing factory. However, it is contemplated that this is merely an example, and the same principles may be applied to any other environment.

Numerous mathematical methods and algorithms have been proposed to automatically build an optimal manufacturing schedule for a day, week, month or the like. The methods and algorithms are based on a variety of approaches such as Tabu search, Simulated Annealing, Genetic, Ant Colony, Grasshopper algorithms, and other heuristic and metaheuristic algorithms. The vast majority of current methods and algorithms for scheduling optimization are primarily concerned with the combinatorial complexity of the scheduling problem and are mainly focused on the speed of convergence to an ‘optimal’ schedule, i.e., the best solution that can be found in practical processing time, which may not be optimal by the above mathematical definition.

The current methods have a number of drawbacks. A first drawback relates to executability and robustness: in real life, ‘surprises’ or unexpected events such as machine breakdown, remake of an urgent part, a task duration taking longer than planned, or the like occur very often and disrupt execution of pre-prepared schedules. By the very nature of inter-relationships between manufacturing operations, almost every change in the schedule may be a root cause for other changes that, in turn, imply their own changes, causing together a complex chain effect that needs to be settled. Recovering from such disruptions in the midst of busy daily operations is more challenging than just a re-run of a computer program, because it involves people and physical real-life objects, thereby making the cost and complexity of changes quite high. Even relatively small ‘surprises’ may lead to radical changes in the original schedules causing excessive cost.

Another drawback of current algorithms is that schedules produced by them are primarily focused on the highest density of the schedule, are likely to include assignments that work against ‘executability’, and their logic is not necessarily intelligible to a human scheduler. As a result, revising a schedule to adapt to changes or disruptions is often frustrating for the scheduler, and in many cases reduces significantly the Z value for the business actual execution.

Yet another drawback of the current methods relates to micro level objectives, that is context-dependent objectives that most users cannot articulate, or that even if they could, are practically prohibitive to model. Quite often a user is presented with a schedule showing an optimal schedule with a satisfactory Z value for the overall objective function set by the user. After reviewing the schedule, the user may start changing the schedule, such as: bringing into the schedule a work-order from a very important customer that was left out. The user may insist on these changes even when they reduce the Z value, due to micro-level objectives that override the macro level objective functions and, business wise, are the right thing to do. Foreseeing all such micro-level objectives ahead of time and incorporating them into the current methods is impractical as they are context dependent, their number could be very large and enumerating them in the original problem formulation is therefore prohibitive.

### BRIEF SUMMARY

One exemplary embodiment of the disclosed subject matter is a computer-implemented method for determining an executable solution for a problem of scheduling work orders within an organization, comprising: obtaining a sample collection of solutions from a solution space of the problem, wherein the sample collection comprising a plurality of solutions to the problem based on a collection of goals, and wherein the sample collection includes one or more solutions optimizing a subset of the goals, the subset of the goals different from the collection of goals; and in an interactive stage: receiving from a user a collection of actual work orders to be executed; and providing to the user a suggested solution for scheduling the actual work orders, the suggested solution based on one or more solutions from the sample collection, wherein the suggested solution is a practical solution. Within the method, said interactive stage can further comprise: receiving from the user one or more changes to the suggested solution; and enhancing the suggested solution to accommodate the changes, thereby obtaining the practical solution to the problem. Within the method, the suggested solution is optionally selected from the sample collection of solutions. The method can further comprise receiving from the user a set of target values, and wherein subject to the sample collection not comprising a solution that complies with the target values, issuing a warning to the user indicating that not all target values can be met. The method can further comprise receiving an updated target value from the user and providing the suggested solution to comply with the updated target value. Within the method, generating the sample collection optionally comprises: obtaining goals of the problem; generating a plurality of solutions, wherein generating each solution from the plurality of solutions comprises: selecting a work order set from an exemplary set of work orders; selecting an objective combination; selecting a work order sequencing algorithm for setting an order in which work orders from the work order set are to be assigned; selecting an assignment algorithm for assigning required resources for each work order; and applying the work order sequencing algorithm to repeatedly select a work order and applying the assignment algorithm for assigning resources to the work order. Within the method, the sample collection is optionally generated on an offline stage. Within the method, the sample collection optionally comprises two or more solutions. Within the method, the subset of the goals optionally comprises exactly one goal from the collection of goals. Within the method, the sample collection optionally depicts an operational envelope of the organization. Within the method, said receiving the change from the user and said enhancing the solution are optionally repeated until the practical solution converges. The method can further comprise receiving from the user an indication for a target value for each of two or more goals, wherein the target value for each goal is indicated independently of other goals and in units appropriate for the goal. The method can further comprise: monitoring execution of the solution to obtain execution data; and using a data item from the execution data to enhance the suggested solution. The method can further comprise: receiving from the user one or more updates to the solution; and incorporating the updates into determination of the sample collection of solutions. The method can further comprise: receiving from the user updates to the solution; receiving from the user a set of target values; verifying that the solution as updated is feasible and complies with the set of target values; and subject to the at least one solution as updated not complying with the target value, providing a warning to the user. The method can further comprise receiving from the user a set of target values, and wherein the indication for each target value is received through a user interface. Within the method, the user interface can optionally limit a target value to values or value range learned from the two or more solutions each optimizing the goal. Within the method, the suggested solution is optionally selected from the sample collection of solutions. The method can further comprise receiving from the user a set of target values, and wherein the solution indicates a point on an operational envelope of the organization, and wherein absence of a suggested solution indicates that the set of target values is external to the operational envelope. Within the method, the suggested solution optionally comprises one or more solutions from the sample collection in which a task are padded by allocating additional resources to the task beyond resources required by the task. Within the method, the additional resources are optionally determined in accordance with deviations in the resources required by the at least one task in past schedules.

One exemplary embodiment of the disclosed subject matter is a method for determining an executable solution for a problem, comprising: generating a sample collection of solutions, each solution in the sample collection representing a solution from a solution space of a problem of scheduling work orders; receiving data related to a scheduling solution created based on the sample collection; and combining the data with the sample collection, thereby learning an enhanced sample collection of solutions. Within the method, the data optionally comprises actual execution data of the schedule. Within the method, the data optionally comprises changes introduced by a user to a solution based on the sample collection of solutions. said learning is optionally unsupervised self-learning. The method can further comprise analyzing execution trends for determining required changes in available resources. The method can further comprise learning trends to be used for long term forecasting and capacity planning based on the sample collection and the enhanced sample collection of solutions.

Yet another exemplary embodiment of the disclosed subject matter is a method for determining an executable solution for a large-scale problem, comprising: obtaining a sample collection of solutions from a solution space of the problem, wherein the sample collection comprising a plurality of solutions to the problem based on a collection of goals associated with the problem, and wherein the sample collection includes a solution optimizing a subset of the collection of goals, the subset of the goals different from the collection of goals; and in an interactive stage: receiving from a user a collection of actual data relevant to the problem; and providing to the user a suggested solution for solving the problem, the suggested solution based on a solution from the sample collection, wherein the suggested solution is a practical solution.

Yet another exemplary embodiment of the disclosed subject matter is a computerized apparatus having a processor, the processor configured to perform the steps of: obtaining a sample collection of solutions from a solution space of a problem of scheduling work orders, wherein the sample collection comprising a plurality of solutions to the problem based on a collection of goals, and wherein the sample collection includes at least one solution optimizing a subset of the goals, the subset of the goals different from the collection of goals; and in an interactive stage: receiving from a user a collection of actual work orders to be executed; providing to the user a suggested solution for scheduling the actual work orders, the suggested solution based on at least one solution from the sample collection; receiving from the user at least one change to the suggested solution; enhancing the suggested solution to accommodate the at least one change, thereby obtaining a practical solution; and providing the practical solution to the user.

Yet another exemplary embodiment of the disclosed subject matter is a computer program product comprising a non-transitory computer readable storage medium retaining program instructions configured to cause a processor to perform actions, which program instructions implement: obtaining a sample collection of solutions from a solution space of a problem of scheduling work orders, wherein the sample collection comprising a plurality of solutions to the problem based on a collection of goals, and wherein the sample collection includes at least one solution optimizing a subset of the goals, the subset of the goals different from the collection of goals; and in an interactive stage: receiving from a user a collection of actual work orders to be executed; providing to the user a suggested solution for scheduling the actual work orders, the suggested solution based on at least one solution from the sample collection; receiving from the user at least one change to the suggested solution; enhancing the suggested solution to accommodate the at least one change, thereby obtaining a practical solution; and providing the practical solution to the user.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic flowchart of a method for solving scheduling or other large-scale problems, in accordance with some exemplary embodiments of the disclosure;

FIG. 2 is a detailed flowchart of a method for the offline stage of sampling a solution space, in accordance with some exemplary embodiments of the disclosure;

FIG. 3 is a detailed flowchart of a method for generating schedules that sample the solution space, in accordance with some exemplary embodiments of the disclosure;

FIGS. 4A, 4B and 4C show an exemplary user interface for manipulating a schedule, in accordance with some embodiments of the disclosure; and

FIG. 5 is a block diagram of a system for solving scheduling or other large scale problems, in accordance with some embodiments of the disclosure.

### DETAILED DESCRIPTION

In the description below, the term “work order” or “job”, is to be widely construed to cover any work that needs to be done to produce an output product, kit, part, or the like. A work order may comprise one or more tasks to be performed at a predetermined order, each with predetermined resources such as machines, human power, materials, tools, or the like.

In the description below, the term “assignment”, is to be widely construed to cover a task or work order assigned to a specific time slot with specified resources such as the machine or station, personnel, raw material, or the like.

In the description below, the term “sequence”, is to be widely construed to cover any ordering of work orders. It is understood that a same combination of work orders may be performed with different sequencing, having different implications on the assignments of certain work orders.

In the description below, the term “schedule” or “solution” is to be widely construed to cover any combination of assignments for work orders and their tasks, such that the required resources are available for executing or performing all the assigned work orders.

In the description below, the term “goal” is to be widely construed to cover a metric for assessing an objective of the organization, such as throughput in terms of number of produced items, due date compliance rate, machine utilization, or the like. The term “target goal” is a numerical value that an organization may aim to achieve, e.g., due date compliance of at least a predetermined value.

Thus “objective function” or “Z function” can be expressed as a weighted combination of goals. For a given schedule, the value of the objective function may represent the quality of the schedule with the aim of finding a schedule that maximizes the objective function.

In the description below, the term “business rule” or “constraint” is to be widely construed to cover a limitation or requirement from the organization to determine valid assignments that can be performed. Some business rules may be strict and must be complied with, for example a material of width 60 cm cannot be cut on a 40 cm cutting machine. Other business rules may be more elastic. For example, the daily schedule needs to be completed by 5 pm, but under certain tight situations, up to a one extra overtime hour is acceptable, although not desirable.

One technical problem dealt with by the disclosed subject matter is the need to solve large scale problems, such as but not limited to scheduling problems. Such problems are, by their nature highly complex. One example to such problems is a manufacturing problem wherein items of multiple types are to be manufactured by a plurality of machines, with a plurality of people, subject to the timely arrival of raw materials, the availability of supporting tools, to be delivered by given due dates, or the like. In this example, the goals of the scheduling may include but are not limited to any one or more, or a combination of the following: maximal number of items produced, maximal utilization of machines and people time, meeting a maximal number of due dates, meeting one or more particular due dates, minimal resource usage, minimal costs, quality levels or the like. An objective function to be optimized by the solution may be defined as a weighted combination of one or more of the goals which provides a quality score, and enables comparison between two solutions.

Other examples may relate to optimal selection of raw material from stock, optimal cutting of parts from materials, or the like.

The description of each such problem may comprise a list of work orders to be scheduled, available resources and business rules that define a valid solution, e.g., a solution that may not be optimal but complies with certain constraints. As detailed above, each work order may comprise one or more tasks.

In classic mathematical approaches, the problem may be formulated by a set of mathematical formulas. Such formulation may involve continuous variables and may be solved by linear programming methods, and/or discrete variables, which may be solved by integer programming.

For problems with discrete variables that involve combinatorial search, techniques such as simulated annealing, Taboo search, genetic algorithms, grasshopper algorithms or others may be used for generating solutions which are optimal or just satisfactory for the user.

However, even after such analysis and refinement, a user, such as a person in charge of scheduling the manufacturing, may not always be able to fully phrase ahead of time in a rigorous manner the objective function, and even an experienced user may always have additional considerations, also referred to as micro level goals, which are hard to express mathematically, may depend on the changing circumstances, or the like.

Moreover, once the requirements, constraints and objectives are given, and a solution is found that complies with the constraints and is mathematically optimal or close to optimal, the user may still be unhappy with the solution for a specific reason, or simply because of a gut feeling that may be based on experience. Additionally, or alternatively, a user may prefer a solution associated with a lower value of the Z function over a solution that received a higher value. For example, in a proposed solution an item required for a major customer may be scheduled to be manufactured towards the end of the work week, and may thus be vulnerable to delays caused by failures in the equipment or in the manufacturing of other items throughout the week. Thus, while the solution is “optimal” it may still be impractical.

Currently available computerized systems and methods may attempt to have the user add ‘micro-level goals’ into the original mathematical objective statement of the problem, such that the optimal schedule will also reflect the micro-level goals, and provide a feasible solution, which may also be mathematically optimal or close to optimal. However, this is impractical or not optimal in business real-life. Although the human user provided or agreed with the objective function and business rules, in certain contexts the user may realize he wishes to modify or replace the provided solution with an alternative one, which he believes to be preferred for good business reasons under the specific circumstances. As the micro-level goals are not always easy to foresee ahead of time, or to express mathematically, a user cannot always phrase, or is even unaware of the micro-level goals, but can recognize that a schedule is sub optimal or inappropriate when he sees it, due to incompliance of the schedule with such goals.

Another technical problem dealt with by the disclosure relates to the robustness of a generated solution to a problem. A schedule should not be only measured by the Z value of its goal-driven metrics, also referred to as Key Performance Indices (KPIs) such as makespan, throughput, or utilization, but also by factors that measure risk and robustness to disruptions during execution, and to facilitate addressing, directly or indirectly, micro objectives. An ‘optimal’ schedule may be so dense as a result of aiming at the best Z scores that it may come at the cost of robustness. Namely, the planned schedule may be very sensitive to disruptive events during execution, events which, in real life occur quite often. For example, longer than planned task duration, raw material late arrival at production stations, machine breakdown, or a new emergency work order that must be inserted into a day's schedule pushing out other pre-planned jobs. Such disruptive events necessitate changes in the planned (originally ‘optimal’) schedule. In a high-density schedule, the change required to respond to a single event may cause a complex chain of additional changes. Multiple such disruption events may worsen the macro Z scores of the actual executed schedule to a level far below those of the planned ‘optimal’ schedule. Therefore, a planned schedule which is mathematically optimal may not necessarily be practically optimal at execution. Moreover, as schedule execution involves people, raw material, and auxiliary equipment in the real world, changes in the planned schedules also have many other negative implications causing excessive cost.

Moreover, typical available systems operate as a black box that search the solution space, whereby assignments are generated and checked for validity and quality, and also for conflicts with other assignments which compete for same resources. However, the user may have no understanding of how and why a certain schedule has been formed.

Yet another technical problem dealt with by the disclosed subject matter is that currently available systems demonstrate minimal if any learning and improvement from planning one schedule to the next, for example from one week to the other. For a given factory, for example, while the demand set may change from week to week, the overall structure in terms of the production lines, the products and their multi-step processes, and the business rules and objectives are fairly stable. However, the system will carry on the same process for generating the schedules instead of learning from previous schedules. Currently available systems may include minimal learning of parameters such as statistics of time duration of a task, if at all, thus inevitably leading to lower ‘robustness’ of their output, as the schedules time and again face reality without learning to adapt to it

One technical solution of the disclosure comprises creating a schedule that is practically optimal in accordance with business considerations, although the obtained schedule may be somewhat inferior to a mathematically optimal solution according to the Z function. However this practically optimal solution has higher degree of robustness and executability and complies with additional considerations which may not be explicitly expressed. Such solution may be more understandable, thereby facilitating user-driven changes. Such a schedule may be named “practicum-optimum”, or “practimum”, as opposed to mathematical optimum. Determining the practical optimum may be based on a discovery process rather than a single optimal point search as done by currently available systems.

The solution combines sampling the solution space, computerized search and additional techniques, artificial intelligence (AI) and in particular machine learning techniques, with experience and expertise of human users, thereby obtaining practically optimal solutions.

The solution comprises executing an offline pre-deployment process of sampling the solution space, thereby obtaining a plurality of solutions that comply with different problem descriptions and aspects. For example, a solution may be generated for one or more combinations created by selecting one item from each of the following categories:

A set of factory settings, including for example specific products, stations, processes, raw material, tools, worker roles, and business rules;

Sets of demand work orders;

Sets of objective weights (objective functions);

Rules/constraints

A set of goals may be defined, such as maximal compliance with due dates vs maximal machine utilization time, or the like.

In the description below, the term “sequencing algorithm” relates to a rule or algorithm for determining the order in which a particular scheduling algorithm assigns the various work orders at hand, which may have great impact on the resulting schedule. For example, if the resources are insufficient for executing all tasks, the first tasks to be considered will get assigned, while the last ones may not, while a different sequencing of the work-orders will result in a different set of tasks getting assigned and executed.

In some embodiments, a solution may be generated for each such combination of work orders. In further embodiments, re-sequencing of the work orders may be applied to a given set of work orders a plurality of times, thereby creating a plurality of schedule options for the same combination of work orders, resources, and assignment algorithm. In such activation or re-activation, work orders that have been highly prioritized may get lower priority and vice versa, thereby generating a different order of the work orders to be assigned and thus a different scheduling solution. One or more goal values may be determined for each such schedule, each value related to one of the goals or a combination thereof.

The operational envelope of an organization may be based on schedules that represent focusing on a rigid limited single goal, or a few goals, for example extreme focus on due date compliance which may come at high cost of low machine utilization and low throughput. The envelope structure provides the tradeoff relationships between the various goals. That is, with a given set of manufacturing resources, what is the maximum score for a certain goal that can be achieved while complying with all business rules, possibly at the cost of all other goals. For instance, if the value of a certain goal on the envelope boundaries is 85%, there is no point setting a performance target for the goal at 88%, because there are no valid schedules that would yield this score, meaning that this target is external to the operational envelope. A 88% goal can be achieved only if other factors are changed, such as the work order combination, the available resources, allowing overtime, or the like. It will be appreciated that a set of targets may be external to the operational envelope if not all target goals can be achieved by the same schedule.

The schedules generated during the pre-deployment stage may include schedules aiming at optimizing a subset of the goals, for example one goal, which may be useful in discovering and depicting the operational envelope of the organization.

The schedules may be stored, along with the parameters upon which they were generated, the values they obtain for each goal, and additional metrics that may be derived, for example via learning algorithms, to obtain additional insights into the solution space. The additional insights or metrics may also serve as search indices that represent similar problems to those seen and solved beforehand in the learning process, in order to arrive faster at an optimal solution of a new problem, based on various parameters, such as the goal values, the parameters, or the various metrics.

The system may then be adapted to the specific factory situations by holding a training and orientation session. During such a session the system may drive a dialogue with its user for obtaining the user's preferences, including for example the relative weights of the various macro level goals, executability considerations, and micro-level objectives.

Assessing a schedule quality by a user usually includes judgmental subjective elements for which the user cannot provide clear-cut rigorous statements, but only statements that are context dependent and ‘soft’ by nature. To discover such elements, the system and method may leverage the created collection of schedules to present the user with concrete examples. Via such a dialogue, the user's subjective judgement is revealed via concrete selection of his preferences, though for certain examples. The system and method may then interpret the user's responses into its schedule generation process. For example, the training and orientation session may comprise presenting to the user pairs of schedules and asking the user to point at the preferred schedule from each pair, thereby assessing the more important goals, characteristics of the preferred schedules, or the like. The system may further ask a user to point at an assignment within a schedule that is problematic and select (or not select) a problem from a predetermined list of reasons. By taking into account the subjective elements of schedule creation, the advantages of humans and artificial intelligence may be combined, thereby providing for improved practimum-optimum solutions.

Having the solutions' data set and optionally the user's preferences, an online or interactive macro planning stage can take place, in which a user provides a pending set of actual work orders, and is presented with one or more optional schedules from the sample of the solution space, or combined upon multiple schedules from the sample, which are estimated as being optimal or most appropriate. The user may also be presented with data such as key metrics, e.g., goal values, and other insights into the schedule, presented for example as a Gantt chart. If the work orders cannot all be executed while complying with the business rules, a corresponding notice may be provided to the user.

Whether a schedule is found or not, the user may iteratively change the work orders, the assignments, the goals, and/or the business rules, in order to obtain a schedule that is better suited to the current needs of the organization.

Once a schedule is provided to a user, an online micro-objective scheduling stage may take place via an online dialogue, where the user may introduce, or request changes to the schedule, and the system may try to accommodate these changes with minimal impact on executability metrics and/or macro-goal values. The user input may also be stored and may serve to make future schedules to be generated by the system address in advance the user driven considerations of micro-objectives and robustness. Such usage of the user input may thus teach the system, such that over time less user involvement will be needed. If the user changes cause the schedule to deviate from one or more of the goals set during the macro planning stage, a corresponding warning may be provided to the user. In some embodiments, the user may approve the deviation and continue with the schedule although it deviates from the goals or constraints the user himself has set. However, in some embodiments, strict constraints may not be overruled. For example, physical constraints such as a 60 cm wide fabric roll may not be cut by a 40 cm wide cutting machine. The dialogue may proceed until the schedule converges to a final practimum-optimum schedule. The schedule may then be distributed for execution to all the relevant entities in the organization.

The practically optimal solution is thus the product of a discovery process of the practimum-optimum, rather than a searching for a single ‘optimal’ point by visiting only narrow parts of the solution space as is currently done by available systems. Additionally, the operational envelope may be discovered along with other insights into the solution space, which may also help during schedule execution and longer term planning.

The schedule may also be monitored during execution, comprising for example collecting information about the execution of each task: when it started and ended, on which station, with what resources, whether there have been any failures, or the like, and certain parameters may be measured and stored for ongoing learning. For example, it may be measured and stored how long the actual execution of a certain task took, how often a raw material arrives late at a production station, or the like.

Another technical solution of the disclosure comprises the system on-going self-learning, also referred to as automatic learning or unsupervised learning, from past schedules, feedback related to on-going usage of the system, including the user's responses and actions, and the execution results. The final schedule may be added to a set of ‘training schedules’, and as time progresses and the training samples include a growing number of real-life schedules, the system and method may learn better the user preferences, the actual execution performance, and the factory characteristics. As a result, the schedule generation process may be streamlined with faster and/or better convergence to the practimum-optimum schedule. For example, if a user constantly moves work orders related to a certain customer or having another common characteristic to earlier time slots, future schedules may be adapted to do that, too. In another example, if certain work order has significant variance in its execution time, wider safety margins may be allocated for the task, such that execution of another task using the same machine as the specific task may not be set to begin immediately following execution of the specific task. The system can thus self-learn the schedule space, including key features, patterns, classes, and other characteristics of high-performance schedules.

The self-learning may include multi-dimensional capacity analysis of the resources, for a variety of volume and mix of work-order demand. Under stressed situations the space of valid schedules could be quite sparse, and finding even a single valid schedule may be a challenge, let alone an optimal one, therefore recognizing stressed situations before running an optimization algorithm is beneficial. Thus, self-learning is not focused on just the assignment of work orders, but rather uncovers the sources of difficulties in determining and executing optimal schedules, such as capacity shortage, bottlenecks, tight business rules, and competing goals. The system may then use these factors in driving the schedule creation and execution processes.

Yet another technical solution of the disclosure relates to the self-learning assisting not only in streamlining future schedule creation, but also in using the knowledge for strategic longer-term forecasting and capacity planning, such as recognizing ahead resource shortage. For example, if the demand volume for Product A is systematically trending up and this may imply the need for additional machine M capacity in the coming 12 months, it may alert that capacity should be increased, by buying more machines, hiring more people, extending work hours, or the like.

One technical effect of the disclosure relates to a method and system for achieving a “practical optimum” solution to complex problems such as large scale scheduling problems. If a full and precise definition of the problem at hand has been available, a solution which is both mathematically and practically optimal could be achieved by current method. However since the problem is not fully defined due to the existence of micro objectives which the user may not even be aware of, the current methods are not applicable for the full real life problem. The solution generated in accordance with the current disclosure may not be mathematically optimal, but is practically optimal and enables compliance with additional considerations and constraints learned from experience and may be crucial in successful execution of the planned schedule, while the user may not have expressed them, either due to their uniqueness, or subjective nature rather than disciplined planning. Thus, the solution may successfully overcome execution instability problems, and the high complexities in recovering from disruptions. A practically optimal solution may be obtained by integrating into the optimization process macro goal metrics such as make-span, due date compliance, throughput, and utilization, as well as factors that provide robustness and leeway breathing space to minimize the impact of disruptions during its execution, and the ability to integrate micro-level objectives. A balanced view on the planned schedule may provide for practical execution with high performance metrics at the end of the schedule period.

The solution thus combines computerized search and additional computerized techniques with artificial intelligence (AI) and machine learning techniques, and with the experience and know-how of human users, thereby enabling the design of a practically optimal solution as described above. The combination provides for sampling the solution space in a manner impossible for a human user, and also utilizes the human knowledge, capabilities and experience.

The solution is practically optimal in that in addition to obtaining a satisfactory Z-score, it is also robust to execution events, and also addresses micro-objectives and executability considerations. The solution also provides for learning of characteristics of the problem environment and its solutions. The disclosed method and apparatus integrate classic search algorithms with learning discovery. The method and apparatus generate a large sample dataset of schedules and apply unsupervised self-learning algorithms for discovering key characteristics of the schedules space, such as the organization envelope for any specific demand set of work-orders that need to be schedule. In some embodiments, the learning results. Once such knowledge is available, it may be used in the short and long term. The knowledge may be used during a dialogue with the user during scheduling, in addressing micro-objectives and executability considerations, such that a solution may converge quickly to a practimum-optimum solution.

Another technical effect of the disclosure relates to a method and system that make efficient use of computing, computer time and human time resources, by performing high resource consuming steps in an offline stage, for example on nights, weekends, or other time slots when users are off, and the computing platforms are not highly loaded, or may even be idle. The results of this processing may then be used during interaction time of the user with the system, which is not computationally heavy, for example during normal business hours, when the computing resources are in higher demand.

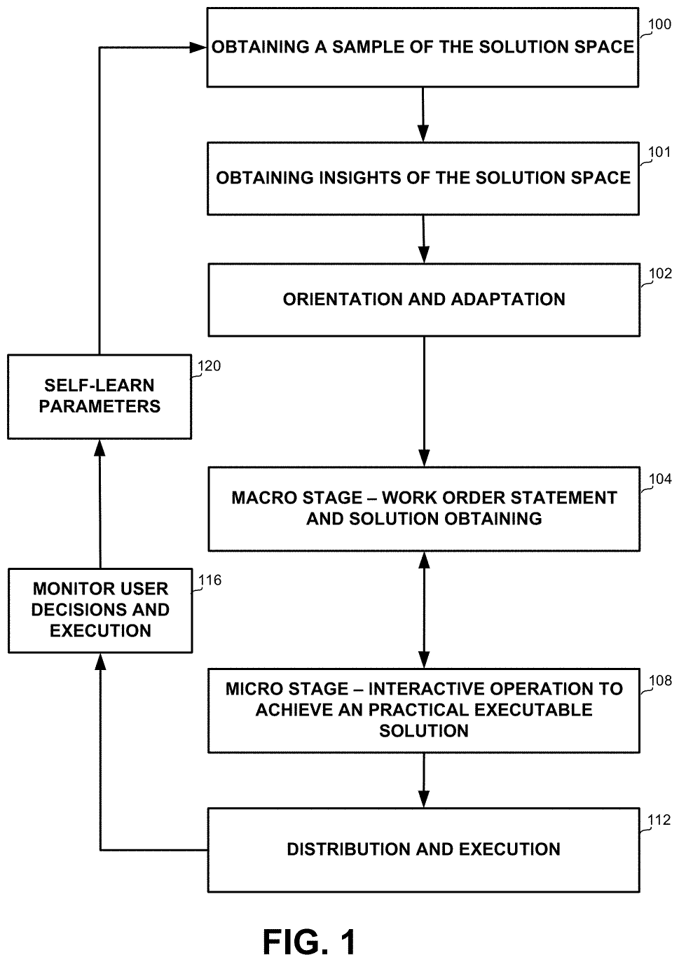

Referring now to FIG. 1, showing a schematic flowchart of a method for solving scheduling or other large scale problems, in accordance with some exemplary embodiments of the disclosure.

On step 100, a sample of the solution space may be obtained. In some embodiments, the sample may be obtained from an external source, such as a storage device, over a network, or the like. In further embodiments, the sample may be generated by automatic algorithms. Either way, the sample may be determined offline when user presence is not required, for example over nights or weekends, or other times when computing resources are available.

The offline stage for sampling the solution space, may be performed pre-deployment of the solution, and also at later times, for example periodically increase the sample set with additional recent samples. In step 100 the problem parameters may be defined, and a plurality of solutions may be generated which sample its solution space.

On step 101, organizational insights may be obtained from the solution space. For example, step 101 may include discovering the operational envelope of the organization, e.g., by examining solutions which focus on optimizing a subset of the goals, such as individual goals. For example, if such a discovery implies that the due date delivery compliance rate of some work order combinations cannot exceed 80%, even if all other goals are compromised or non-existent, then clearly this rate cannot be exceeded in the presence of current business rules.

Step 101 may thus comprise obtaining parameters and goals of the problem, based on a sample collection of solutions from a solution space of the problem.

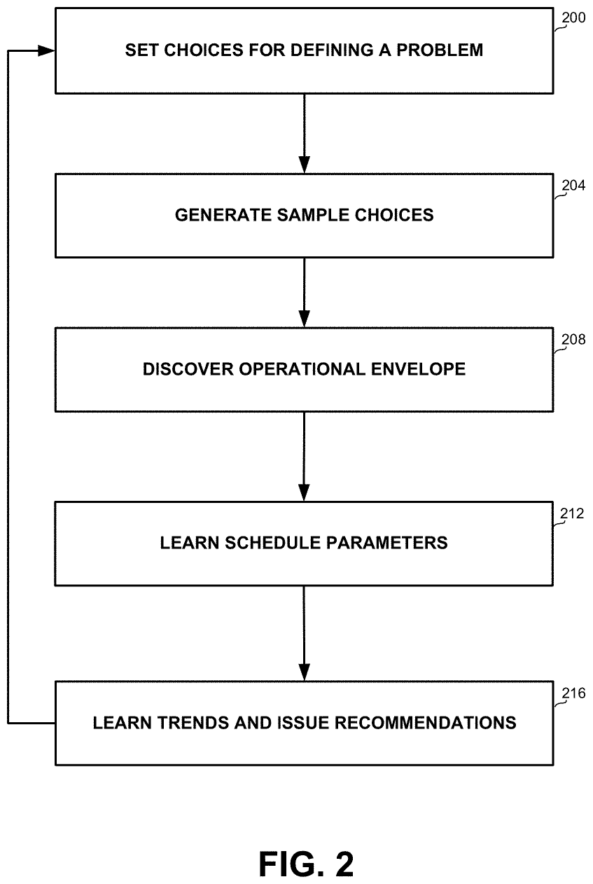

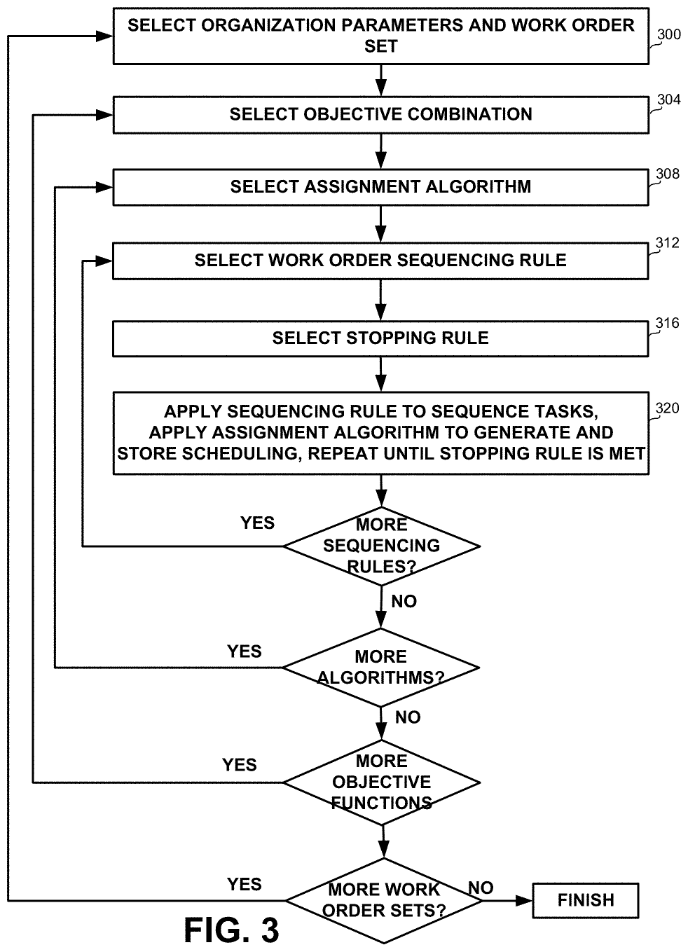

Step 100 is further detailed below in association with FIG. 2 and FIG. 3 below.

It will be appreciated that step 100 may be performed as pre-deployment stage, as well as periodically after usage has started, in order to improve the generated schedules. Step 100 may be based also on the execution of past schedules. For example, offline stage 100 may be performed every week, every month, every year, or the like.

On orientation and adaptation step 102 may be performed, in which the user's general preferences may be obtained or deduced.

For example, the system may present to the user two valid schedules and ask which one is preferable, as opposed to current systems when the user is required to formulate a macro objective function that induces such preferences via the Z value. In another example, the system may present to the user valid schedules and ask the user to point at specific assignments which he thinks are suboptimal or problematic, thereby discovering micro objectives.

On step 104, a macro stage may be performed, in which the work orders to be scheduled are received from a user. The user may then define the work orders and target values for goals of the solution. Step 104 may be performed online, thereby leveraging available solutions that have been generated during the offline stage.

On step 104 the user can define target values for goals of a schedule, using a user interface. The user interface may be graphic and may comprise controls such as sliders, text boxes, or the like. The user may also define the target values as part of orientation and adaptation step 102.

Using the user interface, a target value may be defined for one or more goals, each with its own units. For example, target values may be defined for units throughput, due date violation, and machine time utilization.

A user may define a minimal (or maximal, depending on whether it is a positive or a negative goal) acceptable target value for one or more goals. In some embodiments, a target value exceeding the envelope maximal or minimal value as achieved in discovering the operational envelope of the organization cannot be set. The target values may be set, and the dialogue between the system and the user described below is aimed at obtaining a practical mix of values that can be achieved.

In some embodiments, one or more values may be provided for the same goal, for indicating minimal and maximal values. However, in most cases a user is unlikely to reject a solution in which one or more target values are achieved with a rate of success exceeding a threshold.

It is noted that a user may or may not state the relative importance or weights of the goals. Furthermore, the goals may or may not be scaled, and each goal may be stated in its own units, for example minimal throughput in terms of number of units, minimal percent for due date violation, and percent also for the machine time utilization. This methodology enables the user to leverage best his personal real-world experience in the original units without having to go through technical transformations. Additionally, the user does not have to specify numerically the full set of relative weights. Rather, by setting one or more target values, the user may get the implications on the other target values. The system can then automatically convert any set of pointer locations into numerical relative weights. However, in further embodiments, relationship between the goals may be stated, using any specificity. For example, given four goals G1, G2, G3, and G4, a user may indicate simple ordinal relationship like: “G3 is top priority, then G1, followed by G2 and last priority is G4”, or assign specific weights, such as “40% on G3, 25% on G1, 20% on G3 and 15% on G4”. It will be appreciated that the schemes above are non-limiting, and any other scheme may be used for stating the goals.

It will be appreciated that the mentioned goals are exemplary only, and multiple additional or different goals may be used, such as accumulated cost of raw material for all tasks, percentage or amount of customer deliveries within a predetermined period of time, or the like. It will be appreciated that the goals, their units, and their target values or range may be defined on a preliminary preparation stage. Additionally, or alternatively, some defaults may be provided.

During the on-line stage, one or more valid or mathematically optimal-solutions from the samples obtained on the offline stage may be retrieved and provided to the user with their assignments and goal values. In some embodiments a combination of two or more solutions may be used as the basis for creating the requested solution.

In some situations, no solution can comply with all the constraints and comply with the target values. This can become apparent, for example, due to the target values being outside the operational envelope of the organization as discovered on the offline stage. For example, if under no circumstances, even absence of any other target value, a throughput of over 1000 units can be obtained, then if one of the target value defined by the user is the production of at least 1100 units, then regardless of other goals, this target value cannot be achieved.

In such case, a solution may be provided to the user, which is based on a combination of existing solutions, and/or relaxation of some of the rules.

If still no solution exists, the set of target values may be external to the operational envelope and the user may receive a corresponding message.

If no solution is found, a warning may be issued to the user, indicating that one of the goals or a combination of multiple goals are impossible to achieve.

If the user sets a target value for which no solution exists, with the other target values as is, but a solution may exist for other target values of the other goals, then the values of the other goals may be set automatically to reflect such combination, and to provide a graphic or textual demonstration to the user of the tradeoffs between the goals.

Whether a solution is found or not, the user may manipulate or update the target values, and the provided schedules may change accordingly. This is enabled because all solutions are stored and indexed for fast retrieval. The user may continue manipulating the goals in cases such as when a solution is found which complies with all the goals, but does not comply with the user's preferences as may be based on experience, or for example exceptions to the macro goals, for example “it is necessary to ensure that the work orders of customer X are performed early in the week, to avoid possible delays”, or the like.

Step 104 may thus comprise receiving from a user a collection of work-orders to be executed and optionally an indication for target values for the goals, wherein each target value may be indicated independently of others and in appropriate units. Subject to the representative collection comprising a solution that complies with the target values for the goals, a solution may be selected and provided to the user as a practical solution.

Once a solution is retrieved from among the sampled solutions and displayed, on step 108, an interactive micro-planning stage may be performed, in which a user may receive a suggested solution, iteratively manipulate the solution, for example add, change, amend or delete work orders, change execution order, or the like, until the user converges to a practical executable solution that the user accepts. The system may then enhance the solution to accommodate the changes introduced by the user, for example changing the time or machine for one or more tasks. If the user change cannot be accommodated since the solution contradicts any of the rules, an appropriate notice may be provided to the user, Step 108 may be performed online, in particular as it involves interactive work by the user where the system serves as an assistant facilitating user's changes. This step may be referred to as “practicalizing” the solution, i.e., introducing exceptions to the schedule to accommodate micro objectives, such as important work orders that were left out, or improving its executability by making it more robust to minimize the impact of disruptions during the schedule execution. For example, on this step the user may switch between two tasks on the same machine if this generates some buffer for a task with high variance in its duration. The user input may also serve the learning phase as described in association with step 120 below.

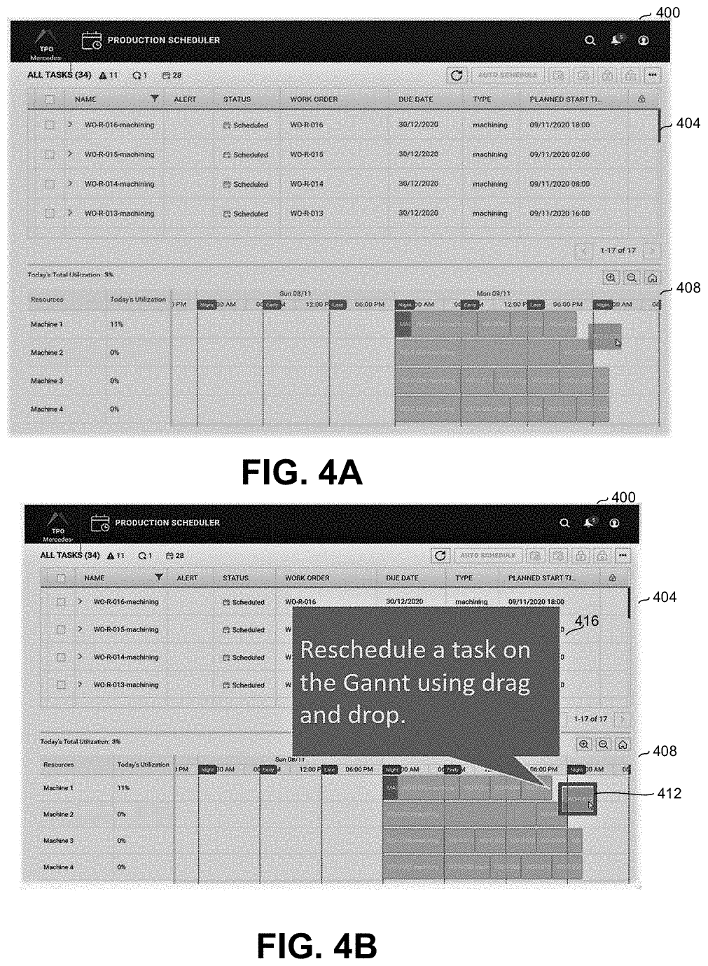

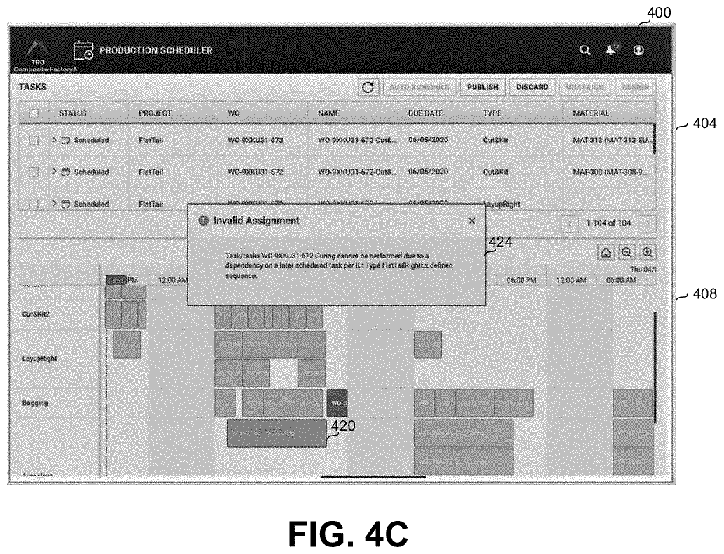

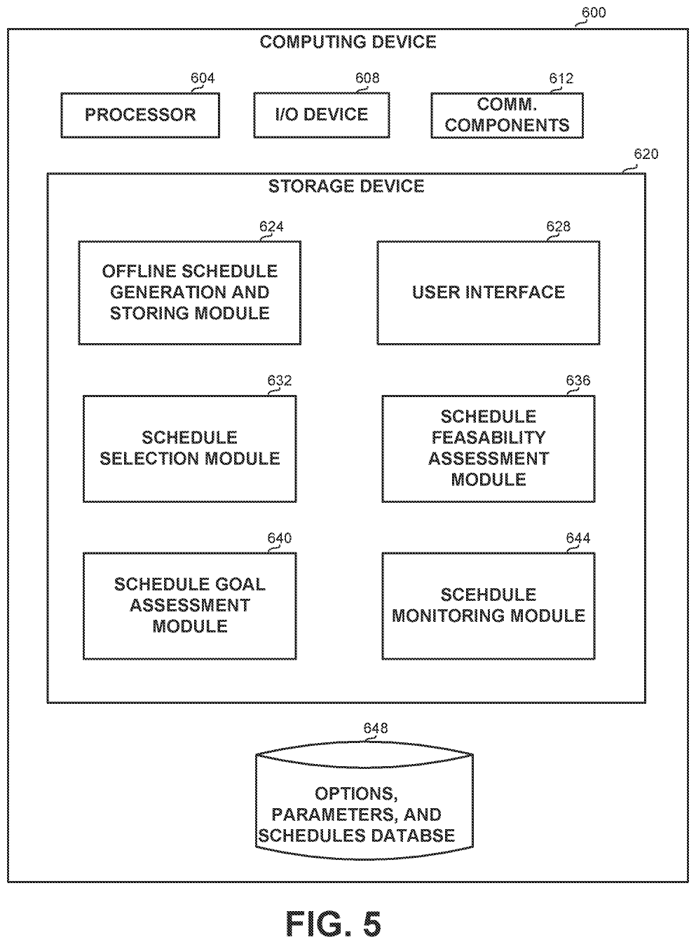

Referring now to FIG. 4A, and FIG. 4B. FIG. 4A shows an exemplary user interface 500, displaying a schedule. User interface 400 comprises a top pane 404 showing the tasks to be executed, and a bottom pane displaying a Gantt 408 of the tasks to be executed by each machine at each time slot. The user may select any of the tasks on Gantt 408, for example task 412, and in response to message 416 may reschedule the task by dragging and dropping it. For example, the user may move the task to another machine and/or to another time slot.

The system may then validate whether the manual assignment is feasible. If the re-assignment is infeasible, the system may issue a corresponding message. Furthermore, if such move degrades the Z value, a corresponding message may be displayed. In any case, the user may insist on the change and lock it, and the system will keep it, for the current and future assignments.

Referring now to FIG. 4C, in which the user has attempted to reschedule task 420, and the system displayed message 424 informing the user that that such re-assignment cannot be performed since it contradicts a rule, such as dependency on a later scheduled task.

If the re-assignment is feasible, then the system may further determine the impact of the re-assignment on any one or more of the goals as defined. In any case, the user may continue re-assigning tasks, or go back to updating the goals on step 104.

Step 108 may thus comprise receiving from the user instructions on what or how to manipulate the displayed solution, and getting from the system feedback on the impact of such manipulations or non-imposing suggestions how to implement the manipulations in better ways.

Once the user has finalized the solution, then on step 112 the solution may be stored, published or distributed to all relevant people, and executed.

During the schedule generation, and during and post-execution, the user decisions and execution data of the schedule may be monitored on step 116. For example, execution time of each work order may be reported, including on which machine an order was executed, execution start time and duration, the amount of raw material used, or the like. Further monitoring data may be obtained from other devices or sensors, including reports by Internet of Things (IoT) devices. For example, a forklift may report whether a cutting role was transported to the required machine and at what time. Further collected data may include changes introduced by a user to suggested schedules during the macro scheduling stage.

On step 120, execution parameters, trends, changes introduced by a user to a solution based on the sample collection of solutions, or other data may be learned from the data collected through monitoring. The learning may be unsupervised self-learning of the collected data.

The learned parameters and/or monitoring data may be provided to step 100, such that it may be used the next time the solution space is learned. Thus, step 100 can utilize the data accumulated up to date and improve the future generated schedules. For example, a task that has significant variance in its execution time, may be padded, i.e., allowed broader time margins, to ensure execution in case it takes longer than standard, or may be scheduled at time slots such that a delay affects minimally other orders, or the like. It will be appreciated that padding may also relate to other resources such as raw material, labor, or the like. In another example, if execution of a task started late due to the raw material not arriving on time, further changes may be introduced, such as arranging for the material to arrive earlier, or postponing the task.

It will be appreciated that self-learning step 120 may be implemented as part of step 100 of sampling the solution space, or as a separate step.

It will be appreciated that although FIG. 1 and the associated description relate to a scheduling problem, the disclosure is not limited to such problem, and can be used for solving any large-scale problem, by obtaining a sample collection of solutions from a solution space of the problem, the solutions based on a collection of goals associated with the problem, wherein some of the solutions may optimize a subset of the goals, and in an interactive stage receive from a user a collection of actual data relevant to the problem; and provide to the user a suggested solution based on one or more solutions from the sample collection, wherein the suggested solution is a practical solution.

Referring now also to FIG. 2, showing a detailed flowchart of a method for the pre-deployment, and on-going, preparation of a sample of the solution space, in accordance with some exemplary embodiments of the disclosure.

On step 200, the choices are set for defining a problem such as but not limited to a scheduling problem. The choices are defined per one factory or organization, however, one system may serve multiple organizations, in which case it may be required to define the choices per organization.

For example, some or all of the following parameter choices may be provided:

A set of factory settings, including for example the product types to be manufactured and their production steps, machines, raw material, tools, processes including which machines are used, the required processing time and additional times such as cooling time, required people, business rules, or the like. As disclosed above, the choices may include one or more sets of factory settings.

Work order sets, also referred to as demand sets, for example a list of work orders to be executed for the time period for which the schedule is being planned, such as a day, week, month, or multiple months. For example, each Friday afternoon a new set of work orders to be scheduled are submitted for the coming week i.e., 52 sets of work orders for the full year. In other embodiments, any number of sets may be provided, depending on changing demand, seasonal changes, or the like.

A set of objectives. In some embodiments, the objectives may be orthogonal to each other, and each may be expressed in a scale and units of its own. For example, the number of units to be produced, the percentage of timely deliveries, minimizing a makespan (the period of time until all tasks are executed), or the like. For the sake of example, three such objective sets may be considered. However, in some embodiments, each objective may be associated with a weight, wherein the weights may be relative, for example add up to 10, 100 or other numbers.

A scheduling algorithm, characterized by the core logics which primarily consists of (a) the sequence in which the work orders are submitted for assignment decisions, and (b) the process by which specific resources are assigned for each work order, such as time slots and machines. In some embodiments, a plurality of algorithms may be used, each associated with a core logics combination.

A sequencing algorithm, i.e., the algorithm for ordering the work orders to be assigned. For example, by their processing time, wherein work orders requiring longer time get higher priority, by their due date, wherein work orders with shorter due date get higher priority, or the like. By assigning work orders A before assigning work orders B, work orders A may be assigned to be executed earlier than work orders B, and this may increase its chances of work orders A to indeed be executed, before delays or other problems occur and accumulate, getting precedence on shared resources, or the like. Changing the assignment order may produce a totally different schedule. For the sake of example, six sequencing algorithms may be considered, wherein each may be executed a plurality of times. It will be appreciated that in some embodiments, the ordering may relate to tasks rather than to work orders.

An assignment algorithm, i.e., the specific assignment decision by which specific resources such as time slots and machines are assigned for each task of a work order. Graphically depicted, this is the logic by which assignments are placed on a Gantt chart. In one example, the algorithm may scan the time dimension, placing all tasks of a work order at the first open time slot according to their order. In another example, the algorithm may scan the machines and select the one which is first available. In further embodiments, further dimensions and dimension combinations may be considered.

On step 204, schedules constituting the solution space may be generated upon the choices provided on step 200.

Referring now to FIG. 3, showing a flowchart of steps in a method for generating schedules for sampling the solution space, in accordance with some exemplary embodiments of the disclosure.

On step 300, an organization (if multiple organizations are handled) and a set of work orders may be selected. The set of work orders may be selected from an exemplary set of work orders, comprising for example a plurality of work orders frequently occurring in the organization. These settings determine a factory with the products it produces, the production line machine steps for each product, time duration, raw material required for each step, and the business rules such as the work shift, e.g., 8 am to 5 pm, and whether overtime is allowed.

On step 304, an objective combination may be selected. The objective combinations may include one or more combinations that optimize a single goal, such as throughput, percent of due date compliance, or the like. Such combinations generate a variety of schedules that may provide the operational envelope of the organization, since it provides a maximal value of the objective when no resources are utilized for attempting to optimize any other objective.

On step 308, an assignment algorithm may be selected, and on step 312 a work order sequencing algorithm may be selected.

On step 316 a stopping rule may be selected, for determining the number of schedules to be generated for each combination. The stopping rule may comprise for example an arbitrary number of schedules to be generated. In other embodiments, the stopping rule may be that per a work order sequencing algorithm, generating the schedules will stop when the difference between the quality of the last generated schedules is below a predetermined threshold, or the like.

On step 320, after all selections have been made, a schedule may be generated, by applying the selected algorithm with the set of parameters as provided on step 300. The schedule may be generated by selecting a set of work orders, applying the sequence rule to sequence the work orders, applying the assignment algorithm to the tasks of the work orders to generate a schedule, and storing the schedule. Step 320 may be iterated until all options made on steps 304, 308, 312 and 316 above are exhausted, or until another stopping criteria has been met, such as a predetermined number of schedules have been generated, a predetermined amount of time has passed, or the like.

Thus, in the example above, if for a single (1) organization the process is performed for 52 weeks, 7 choices of objectives (Step 304), 4 choices of core logics (step 308) and 6 choices of sequencing algorithms, a total of 1×52×7×4×6=8,736 schedules may be generated. This number assumes one demand set of work orders to be scheduled. Thus, if, for example, the same process is applied 5 times for 5 different demand sets, the total number of schedules may amount to 8,736*5=43,680 schedule samples. Each schedule is thus one sample solution in the solution space of all possible schedules.

The generated schedules may be stored, each with the corresponding set of parameter choices upon which it was created, and optionally with the values it assigns to one or more goals and other aspects characterizing the schedule, such as load per machine, completion time of work orders, and the like.

Referring now back to FIG. 2, on step 208, the operational envelope of the organization may be learned, e.g., by generating and analyzing schedules that maximize a subset of the objectives, such as one objective, two objectives, or the like, regardless of the other objectives. It will be appreciated that step 208 may be performed as a standalone step, or as part of schedule generation step 204, where the objectives combinations are comprised of a subset of the objectives.

On step 212, learning and in particular self-learning algorithms may be applied to the collection of sampled schedules to learn characteristics of the overall schedule space, as well as features of individual schedules or groups of schedules, for example the features of group of schedules with similar goal values, e.g., goal values differing at most in a predetermined threshold according to a relevant metrics. In another example, groups of similar schedules that were produced by different sequencing methods or core logics may be discovered. When a user makes a change in a suggested schedule, for example promotes work orders of preferred customers, the system may search for a solution that is similar to the suggested solution, or grouped together with the suggested solution, and complies with the change, for example in which the preferred customer is promoted as required. Thus, the grouping or similarity is used for recommending a schedule in which the specific change is accommodated, with minimal harm to the goals.

Furthermore, once the system is put to use, schedule information, including user decisions in adapting the schedules, and monitoring results of the schedules may be added to the corresponding sample schedules as detailed in association with step 116 of FIG. 1, to enable further self-learning by the system, such as the exception cases that the user typically makes in a given ‘optimal’ schedule.

In non-limiting examples, the following parameters may be learned: the statistical variation of actual time execution of tasks, which is more informative than the fixed time that is typically used in planning schedules, statistics on machine down time, the variation in the amount of raw material actually used, or the like.

The learned parameters may be provided to the offline stage, in order to generate more realistic schedules. The learned parameters may also be used when evaluating whether the changes attempted by a user to a suggested schedule are practically feasible.

It will be appreciated that the parameters may also be learned before the system is deployed, for example by analyzing past schedules, and using the results during the pre-deployment stage.

On step 216, trends of changes in the demand sets for schedule execution and/or trends in the executed schedules, may be analyzed for determining required changes in available resources. In some non-limiting examples, the following trends may be learned: a trend in the volume and mix of the demand set, wherein the demand for a first product is decreasing while demand for a second product is increasing may be a critical finding for capacity planning, such as the timing to purchase equipment to cope with change. Similarly, machine downtime data may point at trends which may be useful for changes in maintenance policies. It will be Appreciated that other trends may be learned, relating on non-limiting examples to personnel, equipment, raw material providers, or the like.

Referring now to FIG. 6, showing a block diagram of the main entities in an apparatus in accordance with some embodiments of the disclosure.

The system may comprise one or more computing platforms 600. In some embodiments, computing platform 600 may be in the Cloud or a computer system on organization premises, and may provide services to one or more clients, such as one or more computing platforms associated with one or more organizations. In further embodiments, computing platform 600 may be the same, or one of the computing platforms executing tasks for a client. In some embodiments edge computing may also be exercised, in which some initial processing is performed by local computers while more resource consuming processing is performed on remote servers, cloud computers or the like.

Computing platform 600 may communicate with other computing platforms whether within the organization, in other organizations or with servers such as cloud servers via any communication channel, such as a Wide Area Network, a Local Area Network, intranet, Internet or the like.

Computing platform 600 may comprise one or more processors 604, which may be one or more Central Processing Units (CPU), microprocessors, electronic circuits, Integrated Circuits (IC) or the like. Processor 604 may be configured to provide the required functionality, for example by loading to memory and activating the software modules stored on storage device 620 detailed below.

It will be appreciated that computing platform 600 may be implemented as one or more computing platforms which may be operatively connected to each other. For example, one or more remote computing platforms, which may be implemented for example on a cloud computer, may be used for training AI engines, or for offline generation of schedules sampling a solution space. Other computing platforms may be a part of a computer network of the organization, and used for providing user interface (UI) for a user for entering input, selecting one or more schedules in accordance with the user's input, and manipulating the schedule. In other embodiments, all the functionality may be provided by one or more computing platform all being a part of the organization network. It will also be appreciated that processor 604 may be implemented as one or more processors, whether located on the same computing platform or not.

Computing platform 600 may comprise Input/Output (I/O) device 608 such as a display device, a speakerphone, a headset, a keyboard, a pointing device, a touch screen, or the like. I/O device 608 may be utilized to receive input from and provide output to a user, for example receive work orders and goals from the user, display suggested schedules to the user, receive manipulation instructions from the user and display the schedules as manipulated.

Computing platform 600 may comprise a storage device 620, such as a hard disk drive, a Flash disk, a Random Access Memory (RAM), a memory chip, or the like. In some exemplary embodiments, Storage device 620 may retain program code operative to cause processor 604 to perform acts associated with any of the modules listed below, or steps of the methods of FIG. 1, FIG. 2 or FIG. 3 above. The program code may comprise one or more executable units, such as functions, libraries, standalone programs or the like, adapted to execute instructions as detailed below.

Storage device 620 may comprise offline schedule generation and storing module 624, for obtaining input parameters relevant for the schedules, as detailed for example in association with step 200 of FIG. 2 above, generating a plurality of schedules for a plurality of input parameter combinations thus sampling the solution space, and storing the schedules with the relevant parameters, for example in a database such as database 648.

In some embodiments, offline schedule generation and storing module 624, and/or database 648 may be implemented on a computing platform remote from the organization, such as a cloud computer or cloud storage device.

Storage device 620 may comprise user interface 628 for displaying information to the user and receiving information form the user. User interface 628 may be implemented separately, for example as separate modules, for the offline stage and the online stages.

Storage device 620 may comprise schedule selection module 632 for receiving parameters including a set of work orders and goals, and selecting or combining one or more schedules prepared during the offline stage.

Storage device 620 may comprise schedule feasibility assessment module 636 for assessing whether a schedule complies with the rules.

Storage device 620 may comprise schedule goal assessment module 640 for determining the goal compliance of a schedule with the one or more goals.

Storage device 620 may comprise schedule monitoring module 644 for monitoring execution of the schedule, for example whether, on what machine, at what time and how long execution of a certain task took, and storing the data such that offline schedule generation and storing module 624 can access it directly or indirectly when generating schedules. In order to collect the information, communication components 612 may communicate with other computing platforms, such as computing platforms associated with the production process.

Storage device 620 may comprise options, parameters and schedules database 648, which may be implemented as part of, or as a separate database accessible to modules of storage device 620. Options, parameters and schedules database 648 may store the various choices of step 200, the various schedules and the parameters associated with each schedule, or other data required for or generated by the system.

It will be appreciated that the module description above is exemplary only, that the modules may be arranged differently, and that the division of tasks between the modules may be different.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, Java, C++, C#, Phyton, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for determining an executable solution for scheduling of work orders, the method comprising:
during a pre-deployment stage, generating a sample collection of solutions from a solution space for a problem of scheduling work orders within a manufacturing factory, said generating performed by automatic learning based at least on data of past work orders and resource combinations and additional work orders and resource combinations, schedules and execution thereof, comprising production line machine steps for each product from a set of products, execution duration, and raw material required for each step, said generating comprising applying first multiple algorithms for generating multiple solutions for multiple optimization goals, each representing a different priority ranking of quality metrics, wherein the sample collection of solutions represents an operational envelope of the manufacturing factory; and
repeating:
monitoring actual execution of a scheduling solution created based on the sample collection, wherein said monitoring comprises obtaining through a communication component at least a report from at least one sensor involved in executing the scheduling solution; and
combining the data with the sample collection, thereby learning an enhanced sample collection of solutions which is based also on actual execution performance, wherein generating the enhanced sample collection of solutions comprises applying second multiple algorithms for generating further work orders and resource combinations with multiple solutions for multiple optimization goals, each representing a different priority ranking of quality metrics, wherein the enhanced sample collection of solutions represents an updated operational envelope of the manufacturing factory, thereby:
increasing a size of a training set of the automatic learning with optimal theoretical cases, to improve scheduling of future work orders.

2. (canceled)

3. The method of claim 1, wherein the data comprises changes introduced by a user to a solution based on the sample collection of solutions.

4. The method of claim 1, wherein said learning is unsupervised self-learning.

5. The method of claim 1, further comprising analyzing execution trends for determining required changes in available resources.

6. The method of claim 1, further comprising learning trends to be used for long term forecasting and capacity planning based on the sample collection and the enhanced sample collection of solutions.

7. The method of claim 6, further comprising determining from the trends future needs for resources, wherein the resources are selected from the group consisting of machines, people, tools, materials, parts and work hours.

8. The method of claim 1, wherein the data of past schedules comprises at least one of required tools and manpower.

9. The method of claim 1, wherein the first multiple algorithms or the second multiple algorithms comprise at least two scheduling algorithms or at least two sequencing algorithms.

10. The method of claim 1, wherein the report is received from an Internet of Things (IoT) device.
